(19) United States
(12) Patent Application Publication
(10) Pub. No.: US 2018/0295151 A1
(43) Pub. Date: Oct. 11, 2018

(54) METHODS FOR MITIGATING NETWORK ATTACKS THROUGH CLIENT PARTITIONING AND DEVICES THEREOF

(71) Applicant: F5 Networks, Inc., Seattle, WA (US)

(72) Inventors: Saxon Amdahl, Portola Valley, CA (US); Peter Finkelshtein, Kiryat Yam (IL); Maxim Zavodchik, Nahariya (IL); Ron Talmor, Sunnyvale, CA (US)

(21) Appl. No.: 15/484,790

(22) Filed: Apr. 11, 2017

(51) Int. Cl. H04L 29/06

(52) U.S. Cl. CPC H04L 63/1441; H04L 63/0876; H04L 63/1408

(57) ABSTRACT

Methods, non-transitory computer readable media, application security management apparatuses, and network traffic management systems that obtain a reputation score for a client. A server is selected based on the reputation score and a session is established with the server. Interaction(s) with an application hosted by the server are monitored. The reputation score for the client is updated based on the interaction(s). A remote fingerprint database and client-side scripts and cookies can be used to obtain reputation scores generated in different domain(s). With this technology, reputations scores are used to direct sessions for relatively benign clients and relatively malicious clients to different server devices so that if the relatively malicious clients conduct a successful attack, only a subset of the servers will be unavailable, and the relatively benign clients will still have access to application(s) hosted by another subset of servers unaffected by the attack.

This application claims the benefit of U.S. Provisional Patent Application Ser. No. 62/320,967 filed Apr. 11, 2016, which is hereby incorporated by reference in its entirety.

### FIELD

This technology generally relates to network security and, more particularly, to methods and devices for mitigating network attacks through client partitioning.

### BACKGROUND

Traffic management devices often sit in front of servers in networks in order to provide security services and improve the end user experience through application acceleration and load balancing network traffic, for example. Traffic management devices are generally configured to load balance network traffic, including malicious network traffic, across a pool of servers in a fair manner. Accordingly, when under an attack, such as a denial of service attack for example, all of the servers of a pool are exposed to malicious network traffic and can therefore be effectively taken out by the attackers leaving no servers to service network traffic associated with legitimate clients.

Further, identifying attackers and attack conditions can be challenging and traffic management policies often restrict legitimate clients due to an inability to distinguish legitimate clients from malicious clients. Distinguishing malicious and legitimate clients is made even more challenging because there is currently no effective way to communicate information regarding malicious or suspicious clients between traffic management devices, particular across domains or in different networks. Accordingly, knowledge acquired in one domain regarding suspicious or malicious clients cannot be effectively shared with traffic management devices in other domains, leaving the other domains susceptible to attack by the same clients.

### SUMMARY

A method for mitigating attacks through client partitioning implemented by a network traffic management system comprising one or more application security management apparatuses, server devices, or client devices, the method including obtaining a reputation score for a client in response to receiving a request to access a resource associated with an application from the client. One of a plurality of servers is selected based on the obtained reputation score and a session is established with the selected one of the servers on behalf of the client. One or more interactions between the client and the application hosted by the selected one of the servers are monitored. The obtained reputation score is updated for the client based on the monitored interactions.

An application security management apparatus, comprising memory comprising programmed instructions stored thereon and one or more processors configured to be capable of executing the stored programmed instructions to obtain a reputation score for a client in response to receiving a request to access a resource associated with an application from the client. One of a plurality of servers is selected based on the obtained reputation score and a session is established with the selected one of the servers on behalf of the client. One or more interactions between the client and the application hosted by the selected one of the servers are monitored. The obtained reputation score is updated for the client based on the monitored interactions.

A non-transitory computer readable medium having stored thereon instructions for mitigating attacks through client partitioning comprising executable code which when executed by one or more processors, causes the one or more processors to obtain a reputation score for a client in response to receiving a request to access a resource associated with an application from the client. One of a plurality of servers is selected based on the obtained reputation score and a session is established with the selected one of the servers on behalf of the client. One or more interactions between the client and the application hosted by the selected one of the servers are monitored. The obtained reputation score is updated for the client based on the monitored interactions.

A network traffic management system, comprising one or more application security management apparatuses, server devices, or client devices, the network traffic management system comprising memory comprising programmed instructions stored thereon and one or more processors configured to be capable of executing the stored programmed instructions to obtain a reputation score for a client in response to receiving a request to access a resource associated with an application from the client. One of a plurality of servers is selected based on the obtained reputation score and a session is established with the selected one of the servers on behalf of the client. One or more interactions between the client and the application hosted by the selected one of the servers are monitored. The obtained reputation score is updated for the client based on the monitored interactions.

This technology has a number of associated advantages including providing methods, non-transitory computer readable media, application security management apparatuses, and network traffic management systems that more effectively mitigate network attacks. With this technology, an attack can advantageously be contained to a subset of servers of a pool, allowing legitimate clients to continue to be serviced by other servers in the pool that are not under attack. This technology also advantageously generates and more effectively distributes useful information between ASM apparatuses in different domains regarding client reputation.

### BRIEF DESCRIPTION OF THE DRAWINGS

FIG. 1 is a system diagram of a network environment with an exemplary network traffic management system;

FIG. 2 is a block diagram of an exemplary application security management apparatus of the network traffic management system shown in FIG. 1;

FIG. 3 is a flowchart of an exemplary method for mitigating attacks through client partitioning;

FIG. 4 is a flowchart of an exemplary method for managing network traffic based on client reputation generated in another domain; and

FIG. 5 is a flow diagram illustrating an exemplary method for managing network traffic based on client reputation generated in another domain.

### DETAILED DESCRIPTION

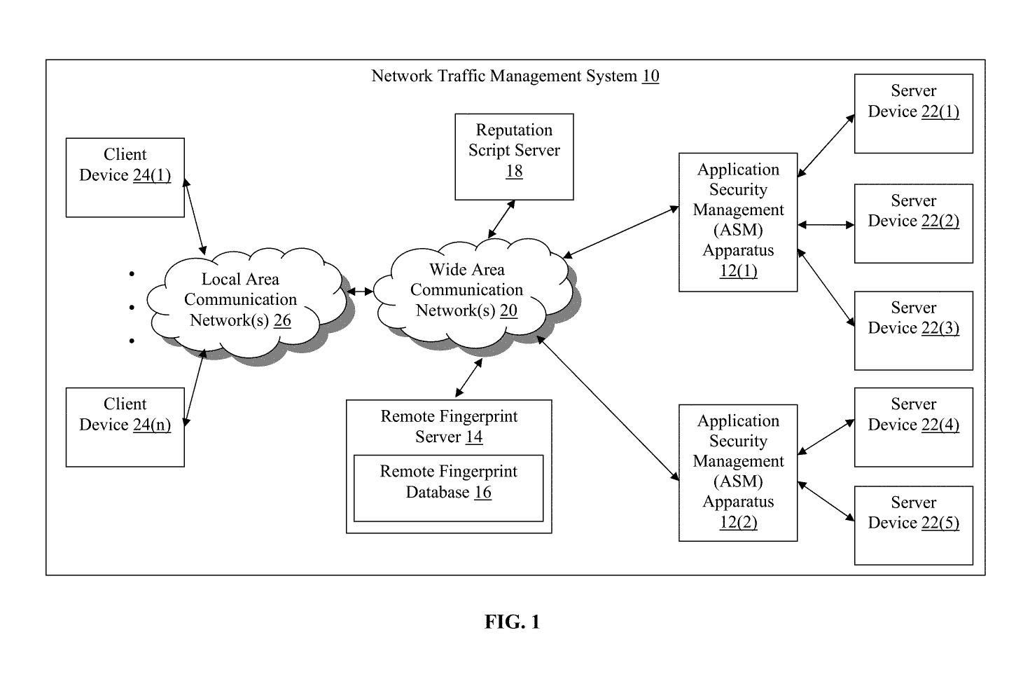

Referring to FIG. 1, an exemplary network environment, which incorporates an exemplary network traffic management system 10 is illustrated. The network traffic management system 10 in this example includes application security management (ASM) apparatuses 12(1) and 12(2) coupled to a remote fingerprint server 14 hosting a remote fingerprint database 16 and a reputation script server 18 via wide area communication network(s) 20, a plurality of server devices 22(1)-22(3) and 22(4)-22(5), respectively, and a plurality of client devices 24(1)-24(n) via the wide area communication network(s) 20 and local area communication network(s) 26, although the ASM apparatuses 12(1) and 12(2), remote fingerprint server 14, reputation script server 18, server devices 22(1)-22(5), and client devices 24(1)-24(n) may be coupled together via other topologies. Additionally, any number of server devices can be coupled to each of the ASM apparatuses 12(1) and 12(2) and the network traffic management system 10 may include other network devices such as one or more routers and/or switches, for example, which are well known in the art and thus will not be described herein. This technology provides a number of advantages including methods, non-transitory computer readable media, ASM apparatuses, and network traffic management systems that more effectively mitigate network attacks by partitioning clients based on reputation such that sessions with relatively legitimate clients are maintained with a subset of server(s) of a pool that are more likely to withstand an attack on the pool from relatively malicious clients.

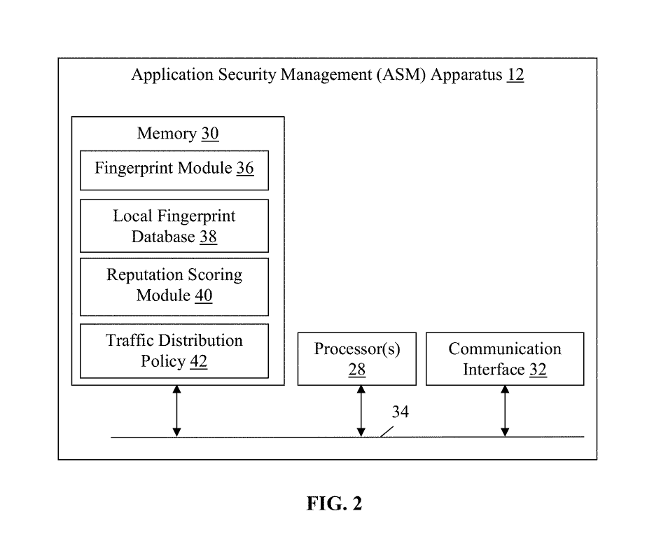

Referring to FIGS. 1-2, each of the ASM apparatuses 12(1) and 12(2) of the network traffic management system 10 may perform any number of functions including managing network traffic, load balancing network traffic across the server devices 22(1)-22(5), accelerating network traffic associated with web applications hosted by the server devices 22(1)-22(5), or providing other security services, for example. Each of the ASM apparatuses 12(1) and 12(2) in this example includes one or more processors 28, a memory 30, and a communication interface 32, which are coupled together by a bus 34 or other communication link, although the ASM apparatuses 12(1) and 12(2) can include other types and numbers of elements in other configurations.

The processor(s) 28 of each of the ASM apparatuses 12(1) and 12(2) may execute programmed instructions stored in the memory 30 of the ASM apparatuses 12(1) and 12(2) for any number of the functions identified above. The processor(s) 28 of the ASM apparatuses 12(1) and 12(2) may include one or more CPUs or general purpose processors with one or more processing cores, for example, although other types of processor(s) can also be used.

The memory 30 of each of the ASM apparatuses 12(1) and 12(2) stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 28, can be used for the memory 30.

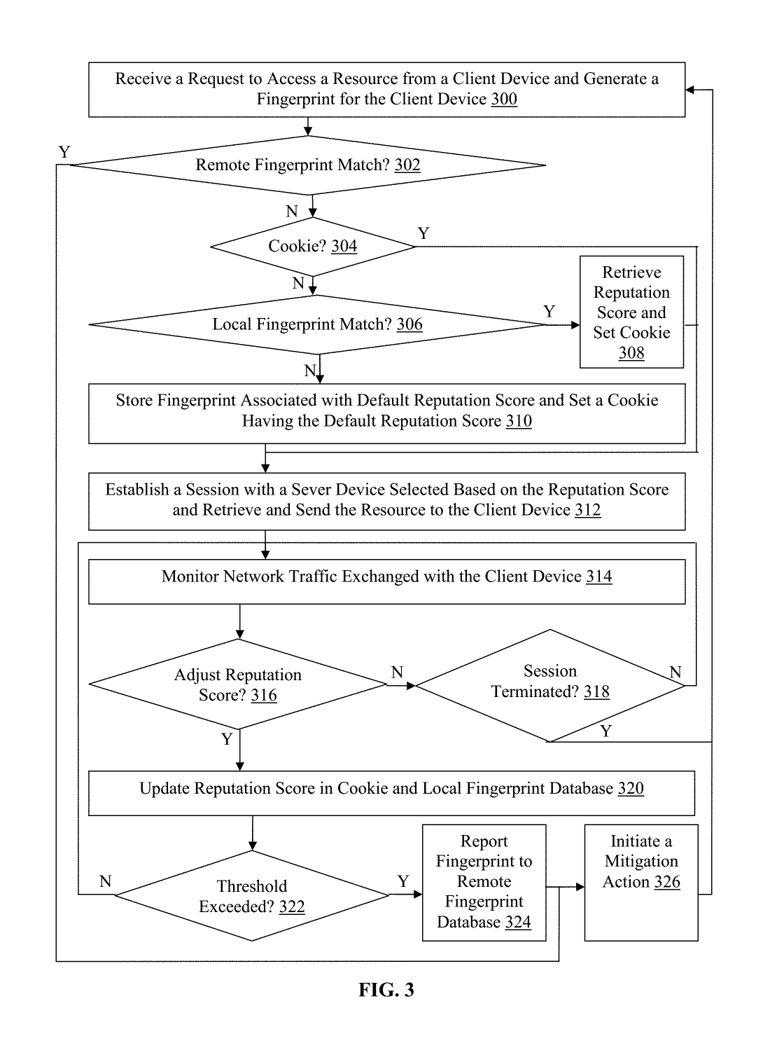

Accordingly, the memory 30 of the ASM apparatuses 12(1) and 12(2) can store one or more applications that can include computer executable instructions that, when executed by the ASM apparatuses 12(1) and 12(2), cause the ASM apparatuses 12(1) and 12(2) to perform actions, such as to transmit, receive, or otherwise process messages, for example, and to perform other actions described and illustrated below with reference to FIGS. 3-5. The application(s) can be implemented as modules, programmed instructions, and/or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the ASM apparatuses 12(1) and 12(2) themselves, may be located in virtual server(s) running in a cloud-based computing environment rather than being tied to one or more specific physical network computing devices. Also, the application(s) may be running in one or more virtual machines (VMs) executing on one or more of the ASM apparatuses 12(1) and 12(2). Additionally, in one or more embodiments of this technology, virtual machine(s) running on one or more of the ASM apparatuses 12(1) and 12(2) may be managed or supervised by a hypervisor.

In this particular example, the memory 30 of each of the ASM apparatuses 12(1) and 12(2) includes a fingerprint module 36, local fingerprint database 38, reputation scoring module 40, and traffic distribution policy 42, although the memory can include other policies, modules, databases, or applications, for example. In this particular example, the fingerprint module 36 is configured to obtain information regarding the client devices 24(1)-24(n) and/or network traffic exchanged with the client devices 24(1)-24(n) that facilitate a unique identification of the client devices 24(1)-24(n).

The fingerprints of client devices 24(1)-24(n) determined to be suspicious or malicious based on reputation score can be reported to the remote fingerprint server 14, which is accessible via the wide area communication network(s) 20 by both of the ASM apparatuses 12(1) and 12(2) in this example. Accordingly, one or more of the client devices 24(1)-24(n) determined to be suspicious or malicious in one domain can be restricted or blocked in another domain, for example, as described and illustrated in more detail later.

The local fingerprint database 38 can store fingerprints of the client devices 24(1)-24(n) with which one of the ASM apparatuses 12(1) and 12(2) has communicated within a historical period of time. The fingerprints are stored as associated with a reputation score for the corresponding one of the client devices 24(1)-24(n). By maintaining the local fingerprint database 38, the corresponding reputation scores can be more effectively maintained and utilized as compared to examples in which cookies are used to maintain reputation scores in a domain, as described and illustrated in more detail later.

The reputation scoring module 40 in this example generates a default reputation score for one or more of the client devices 24(1)-24(n) for which a fingerprint is not stored or a cookie with a reputation score is not provided in an initial request. The reputation scoring module 40 also stores the reputation score in the local fingerprint database 38 and/or sets a cookie for a client session that includes the reputation score. Additionally, the reputation scoring module 40 is configured to monitor various aspects of network traffic including application interactions associated with the client devices 24(1)-24(n), and update the corresponding reputation scores in the local fingerprint database 38 and/or associated cookie accordingly, as described and illustrated in more detail later.

The traffic distribution policy 42 in this example can be established by an administrator and includes rules defining distribution of the network traffic or connections among the server devices 22(1)-22(5) based at least in part on the reputation scores of associated ones of the client devices 24(1)-24(n). Accordingly, in one example, the traffic distribution policy 42 on ASM apparatus 12(1) may require that connections or sessions for those of the client devices 24(1)-24(n) having an associated reputation score that is above zero be directed to server device 22(1), equivalent to zero be directed to server device 22(2), and below zero be directed to server device 22(3), for example.

In this example, a reputation score below zero indicates that the associated client devices 24(1)-24(n) are suspicious or malicious and, therefore, connections associated with those client devices 24(1)-24(n) are directed to server device 22(3). In the event of an attack originating with one or more of the client devices 24(1)-24(n) having a reputation score below zero, only server device 22(3) in this example will be impacted, allowing relatively legitimate client devices 24(1)-24(n) to access the server devices 22(1) and 22(2). Any other types of traffic distribution policies including other types and number of rules based on other reputation scores or other client device or network characteristics can also be used.

The communication interface 32 of each of the ASM apparatuses 12(1) and 12(2) operatively couples and communicates between the ASM apparatuses 12(1) and 12(2), the remote fingerprint server 14, the server devices 22(1)-22(5), respectively, and the client devices 24(1)-24(n), which are all coupled together by the local area communication network(s) 26 and wide area communication network(s) 20, although other types and numbers of communication networks or systems with other types and numbers of connections and configurations to other devices and elements can also be used.

By way of example only, the local area communication network(s) 26 and/or wide area communication network(s) 20 can use TCP/IP over Ethernet and industry-standard protocols, although other types and numbers of protocols and/or communication networks can be used. The local area communication network(s) 26 and/or wide area communication network(s) 20 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The local area communication network(s) 26 and/or wide area communication network(s) 20 can also include direct connection(s) (e.g., for when the device illustrated in FIG. 1, such as the one of the ASM apparatuses 12(1) and 12(2), client devices 24(1)-24(n), or server devices 22(1)-22(5) operate as virtual instances on the same physical machine).

While each of the ASM apparatuses 12(1) and 12(2) is illustrated in this example as including a single device, one or more the ASM apparatuses 12(1) and 12(2) in other examples can include a plurality of devices or blades each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the one of the ASM apparatuses 12(1) and 12(2).

Additionally, one or more of the devices that together comprise one or more of the ASM apparatuses 12(1) and 12(2) in other examples can be standalone devices or integrated with one or more other devices or apparatuses, such the server devices 22(1)-22(5), respectively, for example. Moreover, one or more of the devices of one or more of the ASM apparatuses 12(1) and 12(2) in these examples can be in a same or a different communication network including one or more public, private, or cloud networks, for example.

The remote fingerprint server 14 in this example includes one or more processors, a memory, and a communication interface, which are coupled together by a bus or other communication link, although other numbers and types of network devices could be used. The memory in the remote fingerprint server 14 stores a remote fingerprint database 16, which can be a database (e.g., SQL database) or any other data structure that is configured to store at least client device fingerprints and associated reputation scores.

Optionally, the remote fingerprint server 14 can also host a database management system that is configured to receive and process queries from the ASM apparatuses 12(1) and 12(2) in order to determine whether there is a fingerprint match. The remote fingerprint database 16 facilitates sharing of identifying information in the form of fingerprints of client devices 24(1)-24(n), such as those client devices 24(1)-24(n) identified as suspicious or malicious, across domains, as described and illustrated in more detail later. Other methods of storing and exchanging information regarding fingerprints and reputation scores can also be used.

The reputation script server 18 in this example includes one or more processors, a memory, and a communication interface, which are coupled together by a bus or other communication link, although other numbers and types of network devices could be used. The reputation script server 18 stores a web resource or document that includes a script that, when executed by one of the client devices 24(1)-24(n), is configured to determine when a reputation score is stored by the one of the client device 24(1)-24(n) and communicate the reputation score to another script, as described and illustrated in more detail later.

Each of the server devices 22(1)-22(5) in this example includes one or more processors, a memory, and a communication interface, which are coupled together by a bus or other communication link, although other numbers and types of network devices could be used. The server devices 22(1)-22(5) in this example process requests received from the client devices 24(1)-24(n) via the communication network(s) 20 and 26 according to the HTTP-based application RFC protocol, for example. Various applications may be operating on the server devices 22(1)-22(5) and transmitting data (e.g., files or Web pages) to the client devices 24(1)-24(n) via the ASM apparatuses 12(1) and 12(2) in response to requests from the client devices 24(1)-24(n). The server devices 22(1)-22(5) may be hardware or software or may represent a system with multiple servers in a pool, which may include internal or external networks.

Although the server devices 22(1)-22(5) are illustrated as single devices, one or more actions of each of the server devices 22(1)-22(5) may be distributed across one or more distinct network computing devices that together comprise one or more of the server devices 22(1)-22(5). Moreover, the server devices 22(1)-22(5) are not limited to a particular configuration. Thus, the server devices 22(1)-22(5) may contain a plurality of network computing devices that operate using a master/slave approach, whereby one of the network computing devices of the server devices 22(1)-22(5) operate to manage and/or otherwise coordinate operations of the other network computing devices. The server devices 22(1)-22(5) may operate as a plurality of network computing devices within a cluster architecture, a peer-to peer architecture, virtual machines, or within a cloud architecture, for example.

Thus, the technology disclosed herein is not to be construed as being limited to a single environment and other configurations and architectures are also envisaged. For example, one or more of the server devices 22(1)-22(5) can operate within one or more of the ASM apparatuses 12(1) and 12(2) rather than as a stand-alone device communicating with one or more of the ASM apparatuses 12(1) and 12(2) via the local area communication network(s) 26 and the wide area communication network(s) 20. In this example, the one or more server devices 22(1)-22(5) operate within the memory of one or more of the ASM apparatuses 22(1) and 22(2).

The client devices 24(1)-24(n) in this example include any type of computing device that can request and receive network traffic including web resources such as web pages and web applications, for example. One or more of the client devices 24(1)-24(n) can be a mobile computing device, desktop computing device, laptop computing device, tablet computing device, virtual machines (including cloud-based computers), or the like. Each of the client devices 24(1)-24(n) in this example includes a processor, a memory, and a communication interface, which are coupled together by a bus or other communication link, although other numbers and types of network devices could be used.

The client devices 24(1)-24(n) may run interface applications, such as standard Web browsers or standalone client applications that may provide an interface to make requests for, and receive content stored on, one or more of the server devices 22(1)-22(5) via the local area communication network(s) 26 and wide area communication network(s) 20. The client devices 24(1)-24(n) may further include a display device, such as a display screen or touchscreen, and/or an input device, such as a keyboard for example. Other types of client devices 24(1)-24(n) can include any computing devices configured to host headless browsers, BOTs, or any other types of application that may be used to generate malicious network traffic.

Although the exemplary network environment with the ASM apparatuses 12(1) and 12(2), server devices 22(1)-22(5), client devices 24(1)-24(n), remote fingerprint server 14, reputation script server 18, local area communication network(s) 26, and wide area communication network(s) 20 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment, such as the ASM apparatuses 12(1) and 12(2), server devices 22(1)-22(5), client devices 24(1)-24(n), remote fingerprint server 14 and reputation script server 18 for example, may be configured to operate as virtual instances on the same physical machine. In other words, one or more of the ASM apparatuses 12(1) and 12(2), server devices 22(1)-22(5), client devices 24(1)-24(n), remote fingerprint server 14, reputation script server 18 may operate on the same physical device rather than as separate devices communicating through communication network(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

An exemplary method of mitigating attacks through client partitioning will now be described with reference to FIGS. 1-5. Referring more specifically to FIG. 3, in step 300, the ASM apparatus 12(1) receives a request to access a resource, such as a web application hosted by one of the server devices 22(1)-22(3), from one of the client devices 24(1)-24(n) and generates a fingerprint for the one of the client devices 24(1)-24(n). The fingerprint can be generated based on information regarding the hardware, operating system, browser, and/or network of the one of the client devices 24(1)-24(n) that, together, uniquely identifies the one of the client devices 24(1)-24(n).

The information used to generate the fingerprint can be obtained from header(s) in the received request. In another examples, the ASM apparatus 12(1) can send the one of the client devices 24(1)-24(n) executable code that, when executed by the one of the client devices 24(1)-24(n), is configured to return a portion of the information used to generate the fingerprint, for example. Other methods of obtaining information and generating a fingerprint for the one of the client devices 24(1)-24(n) can also be used.

In step 302, the ASM apparatus 12(1) optionally determines whether there is a match of the generated fingerprint to a fingerprint in the remote fingerprint database 16. The remote fingerprint database 16 in this example stores fingerprints of client devices 24(1)-24(n) that have been identified as suspicious or malicious by other ASM apparatuses, such as ASM apparatus 12(2), for example. Accordingly, a match of a fingerprint may indicate that a mitigation action should be taken on the network traffic originating with the corresponding one of the client devices 24(1)-24(n).

Optionally, the remote fingerprint database 16 stores a reputation score associated with each of the fingerprints, which can allow the ASM apparatus 12(1) to make a more informed decision regarding the mitigation action, as described and illustrated in more detail later. If the ASM apparatus 12(1) determines that there is not a match of the generated fingerprint with a fingerprint in the remote fingerprint database 16, then the No branch is taken to step 304.

In step 304, the ASM apparatus 12(1) determines whether the request includes a cookie that has a reputation score for the one of the client devices 24(1)-24(n). The reputation score is a measure of the likelihood that the one of the client devices 24(1)-24(n) is a legitimate client or a malicious client, and is generated and maintained as described and illustrated by way of one or more examples in more detail later. If the request includes the cookie having the reputation score, then the one of the client devices 24(1)-24(n) likely visited the domain previously, such as by engaging the application hosted by one of the server devices 22(1)-22(3) for example, causing the cookie to be stored locally on the one of the client devices 24(1)-24(n) and transmitted with the request in step 300. If the ASM apparatus 12(1) determines that the request does not include a cookie with the reputation score, then the No branch is taken to step 306.

In step 306, the ASM apparatus 12(1) optionally determines whether the fingerprint generated in step 300 matches a fingerprint in the local fingerprint database 38. If the local fingerprint database 38 includes a matching fingerprint, but the request does not include a cookie, then the one of the client devices 24(1)-24(n) likely visited the domain previously, but the cookie was deleted on the one of the client devices 24(1)-24(n) or was otherwise not sent with the request in step 300.

The local fingerprint database 38 stores fingerprints as associated with reputation scores at the ASM apparatus 12(1), and therefore provides increased persistence of reputation scores as compared to using cookies to maintain the reputation scores client-side. While both cookies and fingerprints are used in this particular example to determine and maintain reputation scores, either method can be used individually in other examples.

If the ASM apparatus 12(1) determines that there is a match of the generated fingerprint in the local fingerprint database 38, then the Yes branch is taken to step 308. In step 308, the ASM apparatus 12(1) retrieves a reputation score that is associated with the matching fingerprint in the local fingerprint database 38 and optionally sets a cookie having the reputation score. By setting the cookie, the ASM apparatus 12(1) can receive the reputation score with subsequent requests from the one of the client devices 24(1)-24(n), unless the cookie is deleted or otherwise manipulated client-side. Optionally, the ASM apparatus 12(1) can determine in step 308 whether the retrieved reputation score indicates that a mitigation action should be initiated, such as blocking network traffic originating from the one of the client devices 24(1)-24(n), for example, and can initiate the mitigation action without processing the request received in step 300.

However, if the ASM apparatus 12(1) determines in step 306 that there is not a match of the generated fingerprint in the local fingerprint database 38, then the No branch is taken to step 310. In step 310, the ASM apparatus 12(1) stores the generated fingerprint associated with a default reputation score in the local fingerprint database 38 and sets a cookie having the default reputation score. In some examples, the reputation score can be zero as a default, which can be increased or decreased based on monitoring of the network traffic, activity, and/or interactions of the one of the client devices 24(1)-24(n), as described and illustrated in more detail later. Subsequent to storing the fingerprint and setting the cookie to have a default reputation score in step 310, or retrieving the reputation score and setting the cookie to have the reputation score, the ASM apparatus 12(1) proceeds to step 312.

In step 312, the ASM apparatus 12(1) establishes a session with one of the server devices 22(1)-22(3) that is selected based on the reputation score and retrieves and sends the resource requested in step 300 to the one of the client devices 24(1)-24(n). Optionally, the ASM apparatus 12(1) can select one of the server devices 22(1)-22(3) by applying the traffic distribution policy 42, although other methods of selecting one of the server devices 22(1)-22(3) can also be used. In this particular example, the traffic distribution policy 42 designates server device 22(1) to handle network traffic originating with those of the client devices 24(1)-24(n) having a positive reputation score above zero, indicating a relative likelihood that they are associated with legitimate users of the application hosted by the servers device 22(1)-22(3).

Additionally, the traffic distribution policy 42 in this example designates server device 22(2) to handle network traffic originating with those of the client devices 24(1)-24(n) having a reputation score of zero, indicating that they likely have not visited the domain previously or that there is otherwise no information available from which the reputation or legitimacy could be determined. The traffic distribution policy 42 in this example further designates server device 22(3) to handle network traffic originating with those of the client devices 24(1)-24(n) having a negative reputation score below zero, indicating that a relatively likelihood that they are associated with suspicious or malicious users of the application hosted by the server devices 22(1)-22(3).

As described earlier, the traffic distribution policy 42 can also require that the ASM apparatus 12(1) initiate a mitigation action such as blocking network traffic originating with one or more of the client devices 24(1)-24(n) having a reputation score that is below a threshold. In other examples, different reputation scores can be used and any number of server devices, including virtual servers can be used, such as to increase granularity of the network traffic distribution.

Accordingly, in step 312, the ASM apparatus 12(1) selects one of the server devices 22(1)-22(3) based on the reputation score retrieved in step 308 or the default reputation score stored in the local fingerprint database 38 and included in the cookie in step 310. Once selected, the ASM apparatus 12(1) establishes a session with the selected one of the server devices 22(1)-22(3) on behalf of the one of the client devices 24(1)-24(n). By partitioning legitimate ones of the client devices 24(1)-24(n), those of the client devices 24(1)-24(n) for which no reputation information is available, and suspicious or malicious ones of the client devices 24(1)-24(n) among the servers 22(1)-22(3) in this particular example, any attack originating with one or more of the suspicious or malicious ones of the client devices 24(1)-24(n) will be limited to server device 22(3) allowing server devices 22(1) and 22(2) to continue servicing requests.

In step 314, the ASM apparatus 12(1) monitors network traffic exchanged with the one of the client devices 24(1)-24(n). Optionally, the reputation scoring module 40 of the ASM apparatus 12(1) can monitor the network traffic to generate transactions per second statistics or request statistics (e.g., number of requests per session) or to identify violations or bad response codes, for example. Additionally, the network traffic can be monitored to determine activity with the application or web site, such as registering an account or purchasing a product, for example. Other network traffic characteristics and/or activities or interactions can also be monitored by the reputation scoring module 40 and used to determine whether the reputation score associated with the one of the client devices 24(1)-24(n) should be adjusted.

For example, if a user of the one of the client devices 24(1)-24(n) purchases a product in the established session with the web application, then the one of the client devices 24(1)-24(n) is more likely to be legitimate and the reputation score for the one of the client devices 24(1)-24(n) can be increased in this particular example. However, if the one of the client devices 24(1)-24(n) is submitting requests with relatively high frequency, then the one of the client devices 24(1)-24(n) is more likely to be suspicious or malicious and the reputation score for the one of the client devices 24(1)-24(n) can be decreased in this example. Optionally, the reputation scoring module 40 can determine whether a reputation score requires adjustment, and the particular extent of the adjustment, based on a stored policy which can define any number of criteria and reputation scores.

If the ASM apparatus 12(1) determines in step 316 that the reputation score for the one of the client devices 24(1)-24(n) does not require adjustment, then the No branch is taken to step 318. In step 318, the ASM apparatus 12(1) determines whether the session established in step 312 has been terminated. If the ASM apparatus 12(1) determines that the session has not been terminated, then the No branch is taken back to step 314 and the ASM apparatus 12(1) continues to monitor network traffic exchanged with the one of the client devices 24(1)-24(n). Accordingly, the ASM apparatus 12(1) effectively monitors network traffic exchanged with the one of the client devices 24(1)-24(n) until a determination is made that the reputation score for the one of the client devices 24(1)-24(n) requires adjustment or the session is terminated.

However, if the ASM apparatus 12(1) determines in step 316 that the reputation score for the one of the client devices 24(1)-24(n)requires adjustment, then the Yes branch is taken to step 320. In step 320, the ASM apparatus 12(1) updates the reputation score for the one of the client devices 24(1)-24(n) in the cookie set in step 308 or 310 and in the local fingerprint database 38.

In step 322, the ASM apparatus 12(1) determines whether a threshold has been exceeded for the reputation score. In this particular example, the threshold may be a negative number indicating that the reputation score has fallen to a level at which the one of the client devices 24(1)-24(n) can be labeled as suspicious or malicious. Different thresholds and any number of thresholds can be used in other examples. Accordingly, if the ASM apparatus 12(1) determines that the threshold has not been exceeded, then the No branch is taken back to step 314 and the ASM apparatus 12(1) continues monitoring network traffic exchanged with the one of the client devices 24(1)-24(n).

However, if the ASM apparatus 12(1) determines in step 322 that the threshold has been exceeded, then the Yes branch is taken to step 324. In step 324, the ASM apparatus 12(1) optionally reports the fingerprint associated with the one of the client devices 24(1)-24(n), and optionally the corresponding reputation score, to the remote fingerprint database 16. By reporting the fingerprint to the remote fingerprint database 16, ASM apparatus 12(2) in this particular example can determine that the one of the client devices 24(1)-24(n) may be suspicious or malicious even though ASM apparatus 12(2) is in a different domain than ASM apparatus 12(1) and may not otherwise have any information by which to determine the legitimacy of the one of the client devices 24(1)-24(n), as described and illustrated in more detail earlier with reference to step 302.

Subsequent to optionally reporting the fingerprint associated with the one of the client devices 24(1)-24(n), or if the ASM apparatus 12(1) determines that there is a match of the fingerprint in the remote fingerprint database 16 in step 302 and the Yes branch is taken, the ASM apparatus 12(1) proceeds to step 324. In step 324, the ASM apparatus 12(1) initiates a mitigation action with respect to the one of the client devices 24(1)-24(n). The mitigation action can be based on a stored policy and, optionally, the reputation score or any number of other characteristics of the one of the client devices 24(1)-24(n) or monitored network traffic originating from the one of the client devices 24(1)-24(n).

In one example, the ASM apparatus 12(1) establishes a session on behalf of the one of the client devices 24(1)-24(n) with server device 22(2) in step 312 and the one of the client devices 24(1)-24(n) initially has an associated default reputation score of zero. Over time in this example, the reputation score declines eventually below the threshold as determined in step 322. Accordingly, the ASM apparatus 12(1) initiates the mitigation action of moving the session established on behalf of the one of the client devices 24(1)-24(n) in step 312 from server device 22(2) to server device 22(3). While the state of the session may not be maintained (e.g., shopping cart contents may be lost), the one of the client devices 24(1)-24(n) will subsequently be partitioned such that any attack originating from the one of the client devices 24(1)-24(n) will advantageously be restricted to server device 22(3).

In another example, the ASM apparatus 12(1) determines that there is a match in the remote fingerprint database 16 and determines that the reputation score in the remote fingerprint database 16 is particularly low. Accordingly, the ASM apparatus 12(1) in this example initiates the mitigation action of blocking the request received in step 300 without performing any of steps 304-324. In yet other examples, the ASM apparatus 12(1) can initiate the mitigation action of rate limiting network traffic associated with the one of the client devices 24(1)-24(n) or sending a challenge to the one of the client devices 24(1)-24(n), for example, and other mitigation actions can also be initiated in step 326.

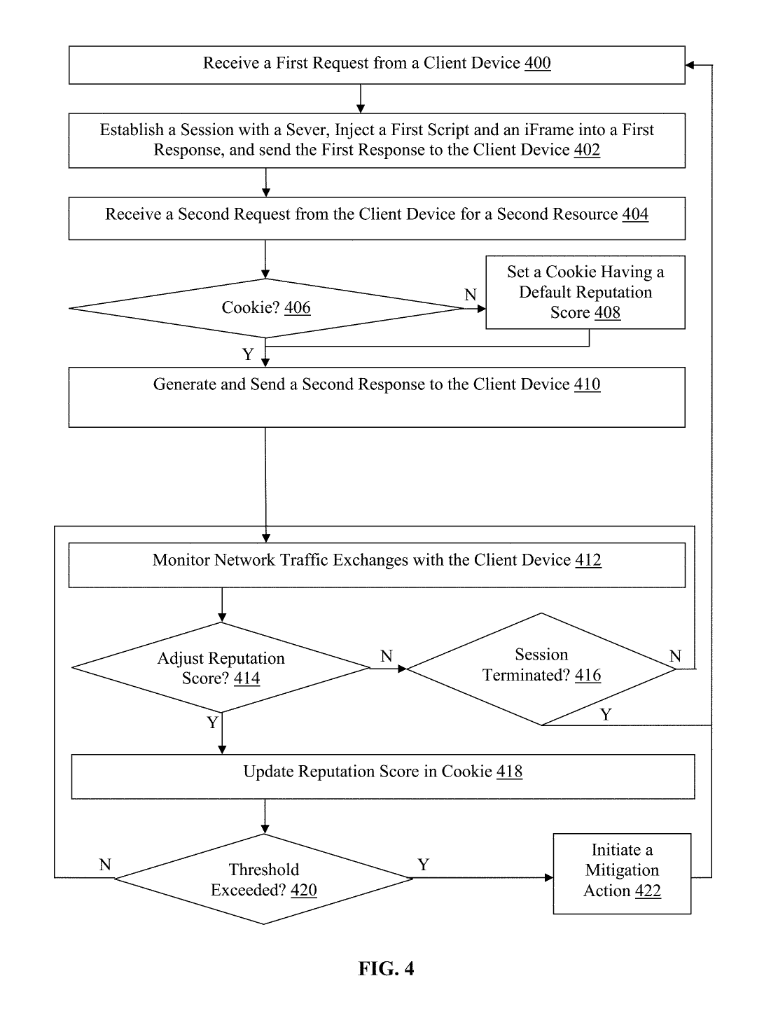

Referring more specifically to FIG. 4, a method for managing network traffic based on client reputation generated in another domain is illustrated. In step 400, the ASM apparatus 12(2) receives a first request from one of the client devices 24(1)-24(n). In this particular example, the one of the client devices 24(1)-24(n) has previously exchanged network traffic with ASM apparatus 12(1), but not ASM apparatus 12(2), and ASM apparatus 12(1) is in a different domain than ASM apparatus 12(2). Additionally, ASM apparatus 12(1) has utilized cookies to set and maintain a reputation score for the one of the client devices 24(1)-24(n). However, because ASM apparatus 12(2) is in a different domain than ASM apparatus 12(1), the cookie set by ASM apparatus 12(1) is not included with the first request received in step 400, and ASM apparatus 12(2) is unable to obtain a reputation score for the one of the client devices 24(1)-24(n) based on the first request.

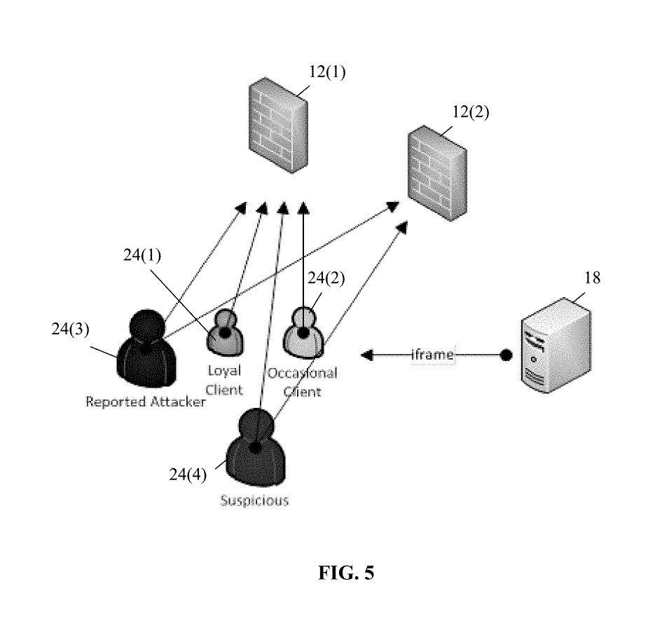

Referring to FIG. 5, a flow diagram illustrating an exemplary method for managing network traffic based on client reputation generated in another domain is illustrated. In this example, a network environment is illustrated with a plurality of users of client devices 24(1)-24(4) and the reputation script server 18. In this particular example, loyal and occasional client devices 24(1) and 24(2), respectively, access ASM apparatus 12(1) and reported attacker client device 24(3) and suspicious client device 24(4) access both ASM apparatuses 12(1) and 12(2).

Based on the method described and illustrated with reference to FIG. 4, ASM apparatus 12(2) can advantageously acquire information regarding the reputation (e.g., a reputation score) of each of the client devices 22(1)-22(4) illustrated in FIG. 5 when the client devices 22(1)-22(4) have first exchanged network traffic with ASM apparatus 12(1). In particular, ASM apparatus 12(2) can advantageously identify client devices 24(3) and 24(4) associated with reported attacker and suspicious users, respectively, that have first communicated with ASM apparatus 12(1) irrespective of whether the remote fingerprint database 16 is utilized by ASM apparatus 12(1) to store fingerprints of those client devices 24(3) and 24(4).

Referring back to FIG. 4, in step 402, the ASM apparatus 12(2) establishes a session with one of the servers 22(4) or 22(5), injects a first script (e.g., executable JavaScript code) and an iFrame into a first response, and sends the first response to one of the client devices 24(1)-24(n). In this particular example, the first response is a web page or other resource requested by the one of the client devices 24(1)-24(n) in the first request and retrieved from the one of the servers 22(4) or 22(5).

The injected iFrame includes an address of a web resource hosted by the reputation script server 18 that includes a second script, although the web resource could be hosted by another device including the ASM apparatus 12(2) itself. The second script, when executed by the one of the client devices 24(1)-24(n), is configured to determine when a reputation score is stored by the one of the client devices 24(1)-24(n) and to communicate the reputation score to the first script, such as using web messaging.

Accordingly, the second script can analyze the one of the client devices 24(1)-24(n) to determine whether a cookie including a reputation score is stored locally on the one of the client devices 24(1)-24(n). Optionally, the ASM apparatus 12(1) and the second script can be preconfigured to use and search for, respectively, cookies with a predefined name or naming convention (e.g., established prefix). Also optionally, the naming convention can include an indication of an application. For example, the cookie set by ASM apparatus 12(1) can be named “TS_APP1”, where TS is a predefined prefix and APP1 indicates an application hosted by the server devices 22(1)-22(3). Other types and numbers of naming conventions and cookies can also be used.

In step 404, the ASM apparatus 12(2) receives a second request from the one of the client devices 24(1)-24(n) for a second resource. In this example, the first script, when executed by the one of the client devices 24(1)-24(n), is configured to receive a reputation score from the second script and set a cookie in a second request that includes the reputation score. If the second script does not identify a cookie with a reputation score stored locally on the one of the client devices 24(1)-24(n), then the second script can be configured not to set any cookie.

Accordingly, in step 406, the ASM apparatus 12(2) determines whether the second request received from the one of the client devices 24(1)-24(n) includes a cookie that includes a reputation score. If the ASM apparatus 12(2) determines that the second request does not includes a cookie with a reputation score, then the No branch is taken to step 408. In step 408, the ASM apparatus 12(2) sets a cookie having a default reputation score, which can be included with a second response to the second request.

In step 410, the ASM apparatus 12(2) generates and sends the second response to the one of the client devices 24(1)-24(n). The second response can be another web page or resource requested in the second request received from the one of the client devices 24(1)-24(n) in step 404. The second response includes the cookie set in step 408 or set by the first script and received with the second request. Optionally, the cookie as sent with the second request and/or the second response can be signed and/or encrypted to increase the reliability of the cookie and reduce the opportunity for tampering.

Accordingly, in examples in which the first script includes a cookie with a reputation score, the ASM apparatus 12(2) is able to obtain, by at least the second request received from the one of the client devices 24(1)-24(n), the reputation score for the one of the client devices 24(1)-24(n) that was established based on network traffic exchanged with the ASM apparatus 12(1) that is in another domain in this example. Based on the reputation score, the ASM apparatus 12(2) can determine whether the session established in step 402 should be moved to a different one of the server devices 22(4) or 22(5), what quality of service or prioritization to provide for network traffic originating from the one of the client devices 24(1)-24(n), whether a mitigation action should be initiated for the one of the client devices 24(1)-24(n), or whether any other number or type of action should be taken.

In step 412, the ASM apparatus 12(2) monitors network traffic exchanged with the one of the client devices 24(1)-24(n). Optionally, the reputation scoring module 40 of the ASM apparatus 12(2) can monitor characteristics and/or activities or interactions associated with the one of the client devices 24(1)-24(n) to determine whether the reputation score associated with the one of the client devices 24(1)-24(n) should be adjusted, as described and illustrated in more detail earlier with reference to step 312 of FIG. 3.

If the ASM apparatus 12(2) determines in step 414 that the reputation score for the one of the client devices 24(1)-24(n) does not require adjustment, then the No branch is taken to step 416. In step 416, the ASM apparatus 12(2) determines whether the session established in step 402 has been terminated. If the ASM apparatus 12(2) determines that the session has not been terminated, then the No branch is taken back to step 412 and the ASM apparatus 12(2) continues to monitor network traffic exchanged with the one of the client devices 24(1)-24(n). Accordingly, the ASM apparatus 12(2) effectively monitors network traffic exchanged with the one of the client devices 24(1)-24(n) until a determination is made that the reputation score for the one of the client devices 24(1)-24(n) requires adjustment or the session is terminated.

However, if the ASM apparatus 12(2) determines in step 414 that the reputation score for the one of the client devices 24(1)-24(n) requires adjustment, then the Yes branch is taken to step 418. In step 418, the ASM apparatus 12(2) updates the reputation score for the one of the client devices 24(1)-24(n) in the cookie set in step 408 or by the first script in step 404. In this particular example, the first script is further configured to, when executed by the one of the client devices 24(1)-24(n), determine when the reputation score in the cookie has been updated and send the updated reputation score to the second script when the reputation score in the cookie has been updated.

Accordingly, the first script monitors the cookie in network traffic exchanged received from the ASM apparatus 12(2) during the established sessions and reports any updates to the second script. The second script in this example is further configured to, when executed by the one of the client devices 24(1)-24(n), receive the updated reputation score and store the updated reputation score on the one of the client devices 24(1)-24(n). In order to store the updated reputation score, the second script can update the cookie with the reputation score that is stored locally on the one of the client devices 24(1)-24(n), for example, although other methods of maintaining the reputation score client-side can also be used.

In step 420, the ASM apparatus 12(2) determines whether a threshold has been exceeded for the reputation score, as described and illustrated in more detail earlier with reference to step 322 of FIG. 3. If the ASM apparatus 12(2) determines that the threshold has not been exceeded, then the No branch is taken back to step 412 and the ASM apparatus 12(2) continues monitoring network traffic exchanged with the one of the client devices 24(1)-24(n).

However, if the ASM apparatus 12(2) determines in step 420 that the threshold has been exceeded, then the Yes branch is taken to step 422. In step 422, the ASM apparatus 12(2) initiates a mitigation action with respect to the one of the client devices 24(1)-24(n), as described and illustrated in more detail earlier with reference to step 326 of FIG. 3.

With this technology, clients can be partitioned among servers in a server pool based on associated reputation scores that are generated based on interactions with web applications. Accordingly, an attack by one or more of the clients can advantageously be contained to a subset of servers of the pool allowing legitimate clients to continue to be serviced by other servers in the pool that are not under attack. This technology also advantageously facilitates useful information for ASM apparatuses regarding the reputation of the clients based on activity associated with the clients that occurred in different domains. With the obtained information, the ASM apparatuses can improve the service provided to the clients as well as mitigate network attacks.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for mitigating attacks through client partitioning implemented by a network traffic management system comprising one or more application security management apparatuses, server devices, or client devices, the method comprising:
obtaining a reputation score for a client in response to receiving a request to access a resource from the client;
selecting one of a plurality of servers based on the obtained reputation score and establishing a session with the selected one of the servers on behalf of the client;
monitoring one or more interactions between the client and an application hosted by the selected one of the servers, wherein the requested resource is associated with the application; and
updating the obtained reputation score for the client based on the monitored interactions.

2. The method of claim 1, further comprising:
generating a fingerprint for the client and determining when the fingerprint matches one of a plurality of fingerprints in a local fingerprint database;
obtaining the reputation score from the local fingerprint database, when the determining indicates that the fingerprint matches one of the fingerprints in the local fingerprint database;
storing the generated fingerprint in the local fingerprint database and storing a default reputation score in the local fingerprint database as associated with the generated fingerprint, when the determining indicates that the fingerprint does not match one of the fingerprints in the local fingerprint database; and
updating the reputation score in the local fingerprint database based on the monitored interactions.

3. The method of claim 1, further comprising:
determining when the received request includes a cookie that includes the reputation score;
obtaining the reputation score from the cookie included in the received request and updating the reputation score in the cookie based on the monitored interactions, when the determining indicates that the received request includes the cookie that includes the reputation score; and
setting another cookie in a response to the received request to have a default reputation score and updating the reputation score in the another cookie based on the monitored interactions, when the determining indicates that the received request does not include the reputation score.

4. The method of claim 1, further comprising:
generating a fingerprint for the client and determining when the fingerprint matches one of a plurality of fingerprints in a remote fingerprint database;
initiating a mitigation action, when the determining indicates that the fingerprint matches one of the fingerprints in the remote fingerprint database;
determining when the updated reputation score exceeds a threshold; and
reporting the generated fingerprint to the remote fingerprint database and initiating another mitigation action or terminating the session and establishing another session with another one of the server devices on behalf of the client, when the determining indicates that the updated reputation score exceeds the threshold.

5. The method of claim 1, further comprising:
injecting a first script and an iFrame into a response to the received request and sending the response to the client, wherein:
the iFrame comprises an address of a resource comprising a second script that is configured to determine when a reputation score is stored by the client and communicate the reputation score to the first script when the determining indicates that the reputation score is stored by the client; and
the first script is configured to receive the reputation score from the second script and set a cookie that includes the reputation score in another request.

6. An application security management apparatus, comprising memory comprising programmed instructions stored thereon and one or more processors configured to be capable of executing the stored programmed instructions to:
obtain a reputation score for a client in response to receiving a request to access a resource from the client;
select one of a plurality of servers based on the obtained reputation score and establish a session with the selected one of the servers on behalf of the client;
monitor one or more interactions between the client and an application hosted by the selected one of the servers, wherein the requested resource is associated with the application; and
update the obtained reputation score for the client based on the monitored interactions.

7. The application security management apparatus of claim 6, wherein the one or more processors are further configured to be capable of executing the stored programmed instructions to:
generate a fingerprint for the client and determine when the fingerprint matches one of a plurality of fingerprints in a local fingerprint database;
obtain the reputation score from the local fingerprint database, when the determining indicates that the fingerprint matches one of the fingerprints in the local fingerprint database;
store the generated fingerprint in the local fingerprint database and store a default reputation score in the local fingerprint database as associated with the generated fingerprint, when the determining indicates that the fingerprint does not match one of the fingerprints in the local fingerprint database; and
update the reputation score in the local fingerprint database based on the monitored interactions.

8. The application security management apparatus of claim 6, wherein the one or more processors are further configured to be capable of executing the stored programmed instructions to:
determine when the received request includes a cookie that includes the reputation score;
obtain the reputation score from the cookie included in the received request and update the reputation score in the cookie based on the monitored interactions, when the determining indicates that the received request includes the cookie that includes the reputation score; and
set another cookie in a response to the received request to have a default reputation score and update the reputation score in the another cookie based on the monitored interactions, when the determining indicates that the received request does not include the reputation score.

9. The application security management apparatus of claim 6, wherein the one or more processors are further configured to be capable of executing the stored programmed instructions to:
generate a fingerprint for the client and determine when the fingerprint matches one of a plurality of fingerprints in a remote fingerprint database;
initiate a mitigation action, when the determining indicates that the fingerprint matches one of the fingerprints in the remote fingerprint database;
determine when the updated reputation score exceeds a threshold; and
report the generated fingerprint to the remote fingerprint database and initiate another mitigation action or terminate the session and establish another session with another one of the server devices on behalf of the client, when the determining indicates that the updated reputation score exceeds the threshold.

10. The application security management apparatus of claim 6, wherein the one or more processors are further configured to be capable of executing the stored programmed instructions to:
inject a first script and an iFrame into a response to the received request and send the response to the client, wherein:
the iFrame comprises an address of a resource comprising a second script that is configured to determine when a reputation score is stored by the client and communicate the reputation score to the first script when the determining indicates that the reputation score is stored by the client; and
the first script is configured to receive the reputation score from the second script and set a cookie that includes the reputation score in another request.

11. A non-transitory computer readable medium having stored thereon instructions for mitigating attacks through client partitioning comprising machine executable code which when executed by one or more processors, causes the processors to:
obtain a reputation score for a client in response to receiving a request to access a resource from the client;
select one of a plurality of servers based on the obtained reputation score and establish a session with the selected one of the servers on behalf of the client;
monitor one or more interactions between the client and an application hosted by the selected one of the servers, wherein the requested resource is associated with the application; and
update the obtained reputation score for the client based on the monitored interactions.

12. The non-transitory computer readable medium of claim 11, wherein the machine executable code when executed by the processors further causes the processor to:
generate a fingerprint for the client and determine when the fingerprint matches one of a plurality of fingerprints in a local fingerprint database;
obtain the reputation score from the local fingerprint database, when the determining indicates that the fingerprint matches one of the fingerprints in the local fingerprint database;
store the generated fingerprint in the local fingerprint database and store a default reputation score in the local fingerprint database as associated with the generated fingerprint, when the determining indicates that the fingerprint does not match one of the fingerprints in the local fingerprint database; and
update the reputation score in the local fingerprint database based on the monitored interactions.

13. The non-transitory computer readable medium of claim 11, wherein the machine executable code when executed by the processors further causes the processor to:
determine when the received request includes a cookie that includes the reputation score;
obtain the reputation score from the cookie included in the received request and update the reputation score in the cookie based on the monitored interactions, when the determining indicates that the received request includes the cookie that includes the reputation score; and
set another cookie in a response to the received request to have a default reputation score and update the reputation score in the another cookie based on the monitored interactions, when the determining indicates that the received request does not include the reputation score.

14. The non-transitory computer readable medium of claim 11, wherein the machine executable code when executed by the processors further causes the processor to:
generate a fingerprint for the client and determine when the fingerprint matches one of a plurality of fingerprints in a remote fingerprint database;
initiate a mitigation action, when the determining indicates that the fingerprint matches one of the fingerprints in the remote fingerprint database;
determine when the updated reputation score exceeds a threshold; and
report the generated fingerprint to the remote fingerprint database and initiate another mitigation action or terminate the session and establish another session with another one of the server devices on behalf of the client, when the determining indicates that the updated reputation score exceeds the threshold.

15. The non-transitory computer readable medium of claim 11, wherein the machine executable code when executed by the processors further causes the processor to:
inject a first script and an iFrame into a response to the received request and send the response to the client, wherein:
the iFrame comprises an address of a resource comprising a second script that is configured to determine when a reputation score is stored by the client and communicate the reputation score to the first script when the determining indicates that the reputation score is stored by the client; and
the first script is configured to receive the reputation score from the second script and set a cookie that includes the reputation score in another request.

16. A network traffic management system, comprising one or more application security management apparatuses, server devices, or client devices, the network traffic management system comprising memory comprising programmed instructions stored thereon and one or more processors configured to be capable of executing the stored programmed instructions to:
obtain a reputation score for a client in response to receiving a request to access a resource from the client;
select one of a plurality of servers based on the obtained reputation score and establish a session with the selected one of the servers on behalf of the client;
monitor one or more interactions between the client and an application hosted by the selected one of the servers, wherein the requested resource is associated with the application; and
update the obtained reputation score for the client based on the monitored interactions.

17. The network traffic management system of claim 16, wherein the one or more processors are further configured to be capable of executing the stored programmed instructions to:
generate a fingerprint for the client and determine when the fingerprint matches one of a plurality of fingerprints in a local fingerprint database;
obtain the reputation score from the local fingerprint database, when the determining indicates that the fingerprint matches one of the fingerprints in the local fingerprint database;
store the generated fingerprint in the local fingerprint database and store a default reputation score in the local fingerprint database as associated with the generated fingerprint, when the determining indicates that the fingerprint does not match one of the fingerprints in the local fingerprint database; and
update the reputation score in the local fingerprint database based on the monitored interactions.

18. The network traffic management system of claim 16, wherein the one or more processors are further configured to be capable of executing the stored programmed instructions to:
determine when the received request includes a cookie that includes the reputation score;
obtain the reputation score from the cookie included in the received request and update the reputation score in the cookie based on the monitored interactions, when the determining indicates that the received request includes the cookie that includes the reputation score; and
set another cookie in a response to the received request to have a default reputation score and update the reputation score in the another cookie based on the monitored interactions, when the determining indicates that the received request does not include the reputation score.

19. The network traffic management system of claim 16, wherein the one or more processors are further configured to be capable of executing the stored programmed instructions to:
generate a fingerprint for the client and determine when the fingerprint matches one of a plurality of fingerprints in a remote fingerprint database;
initiate a mitigation action, when the determining indicates that the fingerprint matches one of the fingerprints in the remote fingerprint database;
determine when the updated reputation score exceeds a threshold; and
report the generated fingerprint to the remote fingerprint database and initiate another mitigation action or terminate the session and establish another session with another one of the server devices on behalf of the client, when the determining indicates that the updated reputation score exceeds the threshold.

20. The network traffic management system of claim 16, wherein the one or more processors are further configured to be capable of executing the stored programmed instructions to:
inject a first script and an iFrame into a response to the received request and send the response to the client, wherein:
the iFrame comprises an address of a resource comprising a second script that is configured to determine when a reputation score is stored by the client and communicate the reputation score to the first script when the determining indicates that the reputation score is stored by the client; and
the first script is configured to receive the reputation score from the second script and set a cookie that includes the reputation score in another request.
